(19) United States
(12) Patent Application Publication
(10) Pub. No.: US 2014/0214707 A1
(43) Pub. Date: Jul. 31, 2014

(54) SOCIAL NETWORK DONATION & CONTRIBUTION SYSTEM

(71) Applicant: Charity IP Investors, LLC, Wilmington, DE (US)

(72) Inventors: David Ian Magedman, Calabasas, CA (US); Joseph Michael Miller, Calabasas, CA (US)

(73) Assignee: Charity IP Investors, LLC, Wilmington, DE (US)

(21) Appl. No.: 14/243,855

(22) Filed: Apr. 2, 2014

Related U.S. Application Data
(63) Continuation of application No. PCT/US2012/040634, filed on Jun. 3, 2012.
(60) Provisional application No. 61/543,551, filed on Oct. 5, 2011.

(51) Int. Cl. G06Q 30/02; G06Q 50/00

(52) U.S. Cl. CPC G06Q 30/0279; G06Q 50/01
USPC 705/319

(57) ABSTRACT

A broker provides an application for use by users of a social network. Using the application the broker obtains, from a first user of said social network, a request from said first user to make a first donation to a first donee entity on behalf of a second user of said social network. In response to payment by said first user of value corresponding to said donation, the broker providing a message to said second user that said donation has been made, said message including a link to said application, and said link identifying said first donee entity. The message and link are displayed on the first or second user's social network web page.

### RELATED APPLICATIONS

This application is a continuation of International Application No. PCT/US2012/040634, titled “Social Network Donation System,” filed Jun. 3, 2012, the entire contents of each of which are hereby fully incorporated herein by reference for all purposes. International Application No. PCT/US2012/040634 is related to and claims priority from U.S. Provisional Patent Application No. 61/543,551, filed Oct. 5, 2011, titled “Social Network Charity System”, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

### Field of the Invention

This invention relates to social networks and, more particularly, to giving donations using social networks.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts a donation/contribution broker system in conjunction with a social network;

FIG. 2 depicts the donation/contribution broker system;

FIG. 3 depicts a social network user's web page;

FIG. 4 is a flow chart showing operation of aspects of the donation/contribution broker system; and

FIG. 5 is a schematic diagram of a computer system.

### DETAILED DESCRIPTION OF THE PRESENTLY PREFERRED EXEMPLARY EMBODIMENTS

Social networks such as Facebook and the like have become widely used on global networks such as the Internet. A social network's users may be individuals or other entities such as, e.g., schools, interest groups, political parties, and the like. As of September, 2011, Facebook claims to have over 750 million active users worldwide (http://www.facebook.com/press/info.php?statistics, Sep. 11, 2011).

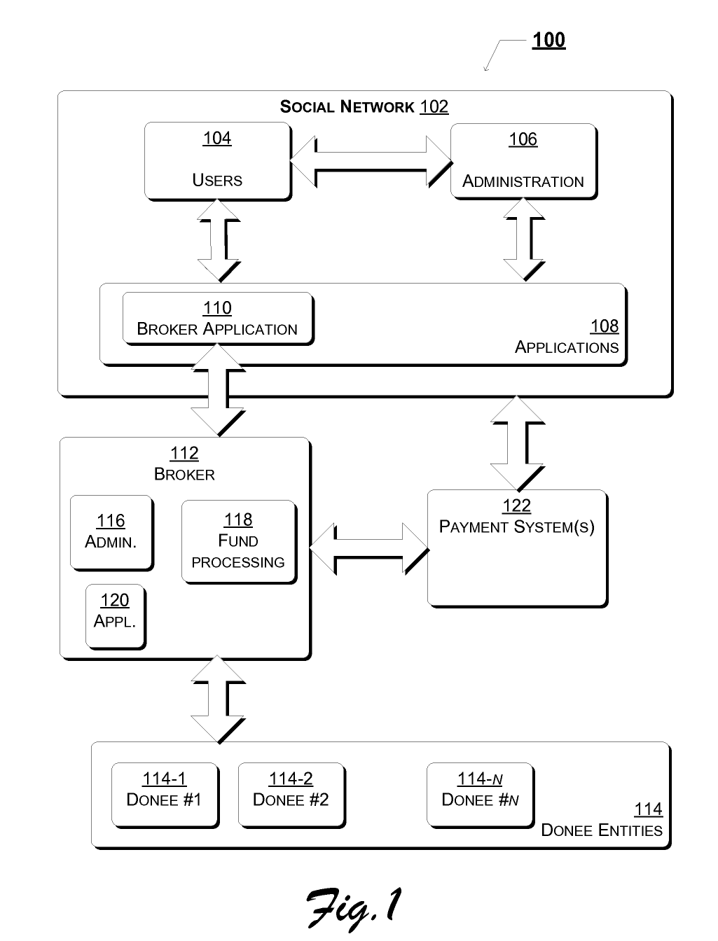

FIG. 1 shows an exemplary social network donation/contribution system (generally denoted 100). A social network 102 comprises users 104. In a typical social network 102 there may be millions of users 104. The social network 102 includes administration mechanisms 106 to deal with various aspects of running the social network. The administration mechanisms 106 typically include mechanisms for dealing with user registration, users' interaction with each other, etc. For the sake of this description, the administration mechanisms 106 are shown as one item or block in the diagram. Those of skill in the art will realize and understand, upon reading this description, that the administration mechanisms 106 may be made up of multiple disparate routines and mechanisms running on multiple computers around the network.

Social network 102 users 104 are provided with one or more interfaces to the social network. Most social networks provide web-based access (e.g., using a browser in a computer, a telephone, or the like). Social networks typically provide various ways for users to interact with each other. In a typical social network (such as social network 102), a user can chose to associate with other users, and users who agree to associate (if agreement is required) are sometimes referred to as “friends”. A user's social network friends may be given access to more information about the user than is provided to non-friends.

According to Facebook, fifty percent (50%) of their active users log on to Facebook in any given day, and an average user has 130 friends. (http://www.facebook.com/press/info.php?statistics, Sep. 11, 2011)

Individual users of a social network 102 typically create a profile that may include personal information (including, e.g., birthdays, wedding anniversaries, etc.). Social network users are typically allowed to create one or more web pages that may include information from their profiles, information about their friends, photographs, written comments, etc. The particular format of a user's web page is generally controlled by the social network, although a user may be given some control of the layout of some information. In some social networks (e.g., Facebook), users' web pages may also be provided with an area in which other users may provide information or comments. In Facebook this area is referred to as a user's “wall”. A user will typically be able to control which other users (e.g., friends) can post information on that user's web page (e.g., on that user's wall).

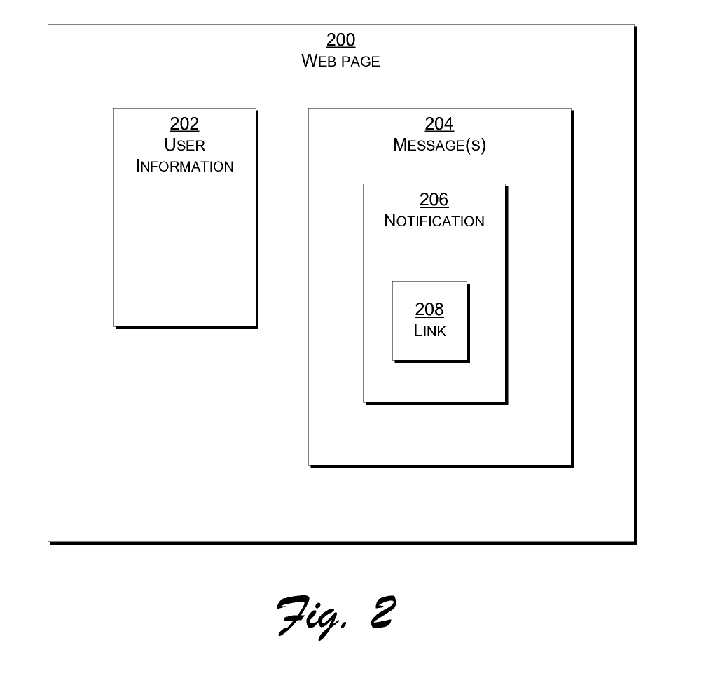

FIG. 2 shows the logical layout of a typical social network user's web page 200. The user's web page 200 includes an area for user information 202 and an area 204 for messages. The messages in area 204 may be from other users (e.g., from friends of the user) or from the user herself (to her friends). The message area 204 corresponds, in part, to a Facebook user's wall.

One common interaction among social network users is for a particular user's friends to post greetings (such as birthday greetings) on that user's wall. In the exemplary user web page 200 in FIG. 2, such greetings may be posted in user's message area 204, e.g., as notification 206.

With reference again to FIG. 1, the social network 102 may include a number of applications 108 (sometimes called “apps”) that users can access and use. These applications may be provided by the social network operator, or they may be third party applications. The social network provides third parties with application programming interfaces (APIs) that allow the third party applications to interact with the social network and its users. One such application is the broker application 110 (described in greater detail below).

### The Broker

One or more donee entities 114-1, 114-2 . . . 114-n (collectively donee entities 114) are connected to a broker 112. The donee entities each make an arrangement with the broker 112 whereby the broker solicits and/or obtains contributions for the respective donee entities from social network users 104.

Although the term “charities” has been used in this description, those of skill in the art will realize and understand, upon reading this description, that a charity may be any entity (or individual) on whose behalf the broker solicits and/or obtains funds. For example, a charity (or donee or donee entity) may be a political party or political action group. The terms “donee” or “donee entity” are used herein interchangeably with the term “charity”. Furthermore, it will be appreciated that the term charity does not imply any legal standing or description, and the entities referred to herein as charities or donee entities need not meet any governmental requirements. The relationship between the broker and the charities does not require any vetting on the part of the broker. It should therefore be appreciated that a donee or donee entity may be any individual or entity, including a political party or political action group.

As part of each donee's subscription to the broker 112, the parties (broker and donee entity) will agree upon any fees that the broker will keep for each contribution made to the donee entity. The fee arrangement may be a percentage of the total contribution amount, a fixed fee, or a combination thereof. Different donee entities may have different fee arrangements with the broker. The parties (broker and donee entity) will also agree on a payment schedule, i.e., on the schedule by which the broker will transfer the payments to the donee entity. The payment schedule may be at regular intervals (e.g., hourly, daily, weekly, etc.) and/or be a function of the amount collected. The broker may charge a different fee for different payment schedules to the same donee entity. For example, the broker may charge a lower fee for monthly transfers than it does for daily transfers. It should be appreciated that a broker may charge no fee.

The broker 112 includes administrative mechanisms 116 to deal with operational aspects such as donee entity registration/subscription, and the like. The broker also includes fund processing mechanism(s) 118 and application mechanism(s) 120 (described in greater detail below) A broker 112 may operate or be operated by or on behalf of a particular donee entity.

The broker application 110 is accessible to users of the social network 102 and provides them with a mechanism for making contributions to one or more of the donee entities 114. Thus, e.g., a user may use the broker application to select a particular donee entity 114-j and to make a contribution to that donee entity.

The broker application 110 interacts with the broker 112 to effect transfer of the users' contributions. Payment may be made using one or more payment system(s) 122, which may include credit card payment systems, vouchers, PayPal, and the like. Payment may be made in different currencies, including internal social network currency.

The fund processing mechanism(s) 118 obtain information about users' donations to donee entities 114. The fund processing mechanism(s) 118 effects the payment of an appropriate amount to the various donee entities, having adjusted for its fees. If the transfer involves a currency exchange, the broker may charge a fee for that exchange too. As noted earlier, the broker's payments to the various donee entities will be made using agreed-upon terms (fees, schedules, etc.), and may differ from donee entity to donee entity.

Payment from the broker to a donee entity may be made in any appropriate (and agreed upon) manner, and those of skill in the art will realize and understand, upon reading this description, that the manner in which such payment is made is not limiting on the scope of the invention.

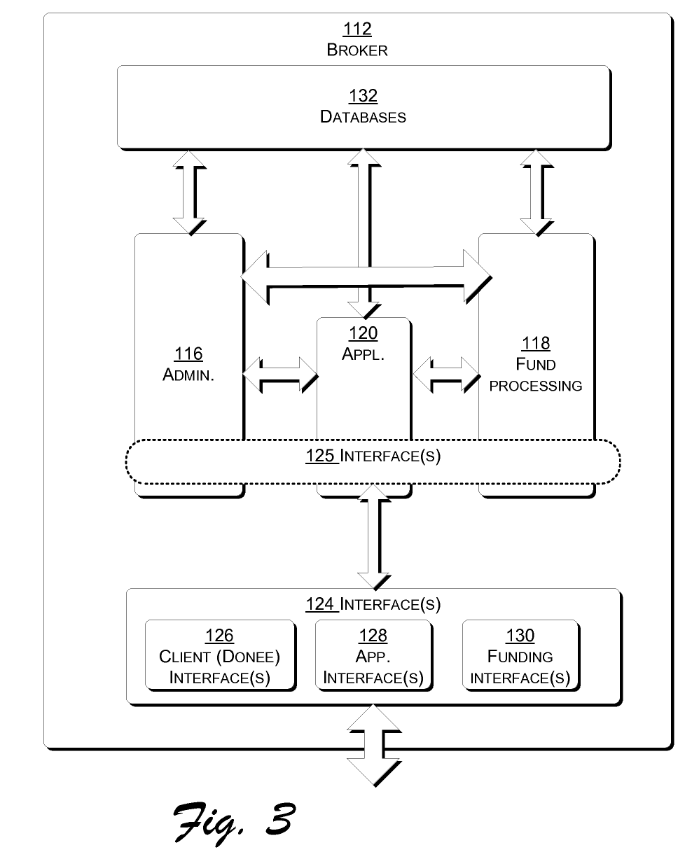

FIG. 3 provides a logical description of the broker 112 of FIG. 1. The broker 112 includes administrative mechanisms 116, fund processing mechanisms 118, and application mechanisms 120. As shown in FIG. 3, the broker 112 includes interfaces 124, 125 including (i) client (donee entity) interface(s) 126 supporting interaction between the broker 112 and the various donee entities 114 that subscribe to the broker; (ii) application interface(s) 128 that are typically internal interfaces supporting interaction between the broker 112 (including application mechanism 120) and the broker application 110; and (iii) funding interface(s) 130 that support interaction between the broker 112 and the payment system(s) 122.

The broker 112 also includes one or more databases 132 to store and maintain information used by the administrative mechanisms 116, fund processing mechanisms 118, and application mechanisms 120. For example, the database(s) 132 include information about registered/subscribed donee entities 114, information about donations made by social network users to the various donee entities 114, information about payments made/owed to the various donee entities, and other information as may be needed for appropriate record keeping. The information stored in the database(s) 132 may be stored and maintained in any known way, and those of skill in the art will realize and understand, upon reading this description, that the invention is not limited by the exact information stored and the exact manner in which the information is stored.

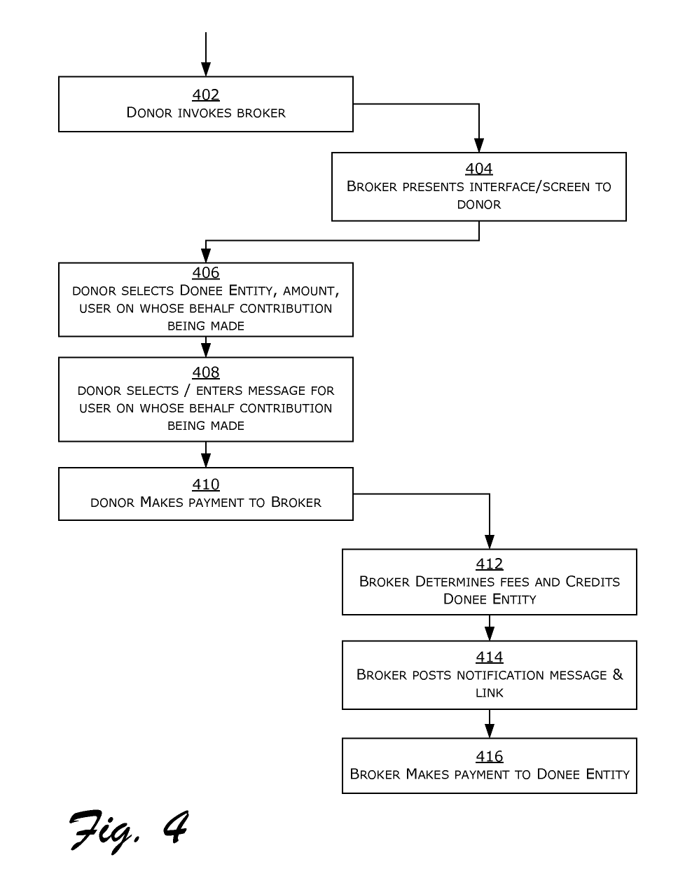

Operation of the system is described with reference to the flow chart in FIG. 4. In operation, a first user of the social network 102 chooses to make a donation to a donee entity on behalf of a second user. For the purposes of this description, the first user may be referred to as the donor. The donor may be making the donation as a gift to the second user, e.g., on the second user's birthday.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering. Similarly, the word “donor” is used to identify a user, and is not intended to be limited by any legal meaning of the word.

The donor invokes the broker application 110 (via the donor's interface to the social network, e.g., via a web page) (at 402). In response, the broker application 110 presents the donor with a screen or other interface to the broker's donation system (at 404).

Using this interface, the donor informs the broker application of (a) a donee entity to which the contribution is to be made; (b) the amount being contributed; and (c) the user on whose behalf the contribution is being made (in this case, the second user or the user making the contribution) (at 406). The broker application may provide potential donors with a list of donee entities that subscribe to the broker and may provide other ways (e.g., a search function) to allow donors to select a donee entity. The search function may allow searching by interest or category as well as by name. For example, a user may look for donee entities that save whales, feed hungry people, etc.

The donor may then enter a message for the user on whose behalf the donation is being made (at 408). The donor may enter their own message or may select some or all of one or more preset messages (e.g., “Happy birthday. Donor has donated ?X on your behalf to PQR in celebration of your birthday.”). Those of skill in the art will realize and understand, upon reading this description, that a use may make a donation or contribution on their own behalf.

Preferably each subscribing donee entity 114 will also have a web page or other information that the user can access to find out more about the donee entity. The web page may also be a web page in the social network (so that the donee entity may also be a user of the social network). A broker may provide a branded web page for a donee entity, whereby the broker web page is the same as the donee entity's web page.

Users of the broker 112 may be provided with a breakdown of the fees collected by the broker as well as the administrative overheads of the donee entities.

Having selected a donee entity and a donation amount, the broker application 110 interacts with the user to affect the transfer of the funds to the broker (at 410). The broker application may use any payment system (e.g., credit card, PayPal, or the like) to transfer the donated amount to the broker.

The broker then credits the appropriate amount to the donee entity (after deducting its fees, commissions, etc.) (at 412). At an arranged time, the broker makes payment to the donee entity (at 416).

When the donor's payment to the broker is confirmed, a message from the donor is posted on the second user's message board (e.g., Facebook wall), indicating that a donation was made to the donee entity on behalf of the second user (at 414). The posted message is the message selected/entered by the donor in 408). The indication may be posted as a notification 206 in the message section 204 of the second user's web page 200. The notification 206 may include the amount of the donation. The notification 206 preferably includes a link 208 to the broker application 110. Preferably the link 208 identifies the donee entity selected by the donor. Other users may select the link 208 (in a known manner such as using a mouse click or the like) to get directed to the broker application 110. When other users are directed to the broker application 110, they may be directed to a donation page for the same donee entity as was selected by the first user/donor. The donation page may allow subsequent users to make the same donation as the first user or multiples thereof, and/or it may allow subsequent users to make donations to different donee entities.

In some embodiments, a user may post a link to the broker 112 on her own web page, providing her friends with information about her preferred donee entity (or donee entities). In this manner, that user's friends can tell from her social network web page where they should make donations on her behalf

### Example 1

In this example, a particular person is a Facebook user. On her birthday, her Facebook friends donate money to one or more donee entities using the broker 112. Each donation causes a notification to be posted on the person's Facebook page indicating the donor, donation and recipient, and each notification may include a link to the broker to allow other users to make similar donations. For example, the messages may say “Jane Doe donated ?100 to Save the Wales in honor of Mary Doe's birthday.”

The postings act as advertising on the electronic social networks to induce others to make gifts in honor of specific events, or charities or holidays, official 501c3 charity or otherwise. Using legal tender, or utilizing stored value credits (Facebook Credits) or anything else of value.

### End of Example 1

### Example 2

In this example, one of the “charities” or donee entities is a political action committee (PAC), trying to raise money for a particular political issue or candidate. The PAC is a user of the social network and also has a separate web site. The PAC includes a link on its social network page to the broker 112. That link includes information about the PAC, so that any user selecting that link will be directed to the broker 112 and to a specific page for that PAC in the broker 112. Users can then make political contributions to that PAC via the link on the PAC's web page. These contributions may be made on behalf of other users of the social network.

### End of Example 2

### Example 3

In this example, one of the donee is a candidate for political office. The candidate is a user of the social network (e.g., Facebook) and also has a separate web site. The candidate's web site includes a link on its social network page to a co-branded broker 112. That co-branded broker web site includes information about the candidate, so that any user selecting that link will be directed to the co-branded broker 112. Since the broker is specific to the candidate, the broker's web site provides information for that candidate. Users can then make political contributions to that candidate via the link on the candidate's web page. These contributions may be made on behalf of other users of the social network. A particular user of the social network can make a political contribution to the candidate (on their own behalf or on behalf of another user of the social network). To do so the user selects the co-branded broker link on the candidates web page (or on their social network page). The user is directed to the co-branded broker where they make their contribution. The user can then select to designate where a link and message about that contribution will appear. For example, the user can designate that a link and message about that contribution will appear on their own social network page (e.g., on their own Facebook wall) or that a link and message about that contribution will appear on another user's social network page. So, for example, a user John Doe can have a link and message on his own Facebook wall that says “John Doe contributed ?100.00 to the campaign of Cathy Candidate. Click here to contribute.”. Other users can select that link to make their own contributions to that political candidate. Alternatively, user John Doe can have the link and message appear on another user's (e.g., Murray Moe's) web page, so that Murray Moe's Facebook wall will have a link to the co-branded broker and a message such as “On behalf of Murray Moe, his friend John Doe contributed ?100.00 to the campaign of Cathy Candidate. Click here to contribute.”

### End of Example 3

Although the description has been provided for a single social network, those of skill in the art will realize and understand, upon reading this description, that the broker may operate with more than one social network. Similarly, a particular individual may be a member/user of more than one social network.

### Computing

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

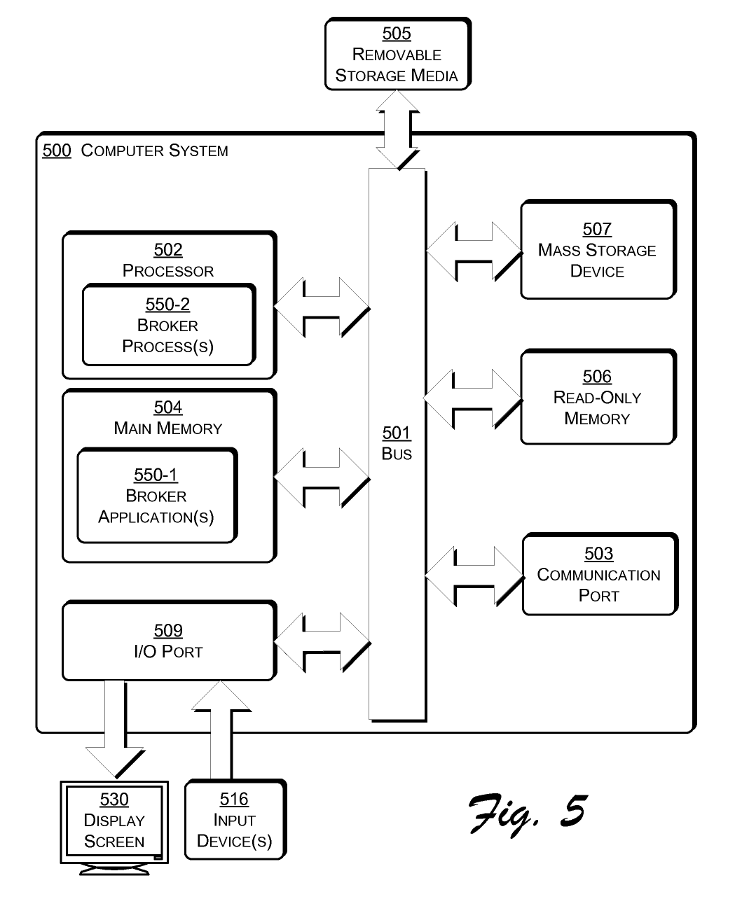

FIG. 5 is a schematic diagram of a computer system 500 upon which embodiments of the present disclosure may be implemented and carried out.

According to the present example, the computer system 500 includes a bus 501 (i.e., interconnect), at least one processor 502, at least one communications port 503, a main memory 504, a removable storage media 505, a read-only memory 506, and a mass storage 507.

Processor(s) 502 can be any known processor, such as, but not limited to, an Intel® Itanium® or Itanium 2® processor(s), AMD® Opteron® or Athlon MP® processor(s), or Motorola® lines of processors, and the like. Communications port(s) 503 can be any of an RS-232 port for use with a modem based dial-up connection, a 10/100 Ethernet port, a Gigabit port using copper or fiber, or a USB port, and the like. Communications port(s) 503 may be chosen depending on a network such as a Local Area Network (LAN), a Wide Area Network (WAN), a CDN, or any network to which the computer system 500 connects. The computer system 500 may be in communication with peripheral devices (e.g., display screen 530, input device(s) 516) via Input/Output (I/O) port 509.

Main memory 504 can be Random Access Memory (RAM), or any other dynamic storage device(s) commonly known in the art. Read-only memory 506 can be any static storage device(s) such as Programmable Read-Only Memory (PROM) chips for storing static information such as instructions for processor 502. Mass storage 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 501 communicatively couples processor(s) 502 with the other memory, storage and communications blocks. Bus 501 can be a PCI/PCI-X, SCSI, a Universal Serial Bus (USB) based system bus (or other) depending on the storage devices used, and the like. Removable storage media 505 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 504 is encoded with application 550-1 that supports the functionality as discussed herein. Application 550-1 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 502 accesses main memory 504 via the use of bus 501 in order to launch, run, execute, interpret or otherwise perform the logic instructions of the interface application 550-1. Execution of application 550-1 produces processing functionality in process 550-2. In other words, the process 550-2 represents one or more portions of the application 550-1 performing within or upon the processor(s) 502 in the computer system 500.

It should be noted that, in addition to the content delivery process 550-2 that carries out operations as discussed herein, other embodiments herein include the application 550-1 itself (i.e., the un-executed or non-performing logic instructions and/or data). The application 550-1 may be stored on a computer readable medium (e.g., a repository) such as a floppy disk, hard disk or in an optical medium. According to other embodiments, the application 550-1 can also be stored in a memory type system such as in firmware, read only memory (ROM), or, as in this example, as executable code within the main memory 504 (e.g., within Random Access Memory or RAM). For example, application 550-1 may also be stored in removable storage media 505, read-only memory 506, and/or mass storage device 507.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of skill in the art will appreciate that the process may operate without any user intervention. In another embodiment, the process includes some human intervention (e.g., a step is performed by or with the assistance of a human).

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A computer-implemented method, implemented by hardware in combination with software, the method comprising:
obtaining, from a first user of a social network, a request to make a first donation or contribution to a first entity; and
in response to payment by said first user of value corresponding to said donation or contribution, causing a message to be provided to a second user of said social network, wherein said message is provided to said second user via said social network, the message being provided by causing the social network put the message on a web page associated with the second user, said message including an indication that said donation has been made to said first entity, said message including a link and identifying said first entity.

2. The method of claim 1 further comprising:
in response to a third user of said social network selecting said link, obtaining from said third user a request to make a second donation or contribution to said first entity; and
in response to payment by said third user of value corresponding to said second donation or contribution, causing a second message to be provided to said second user, said second message indicating that said second donation has been made to said first entity, wherein said second message is provided to said second user via said social network, the second message being provided by causing the social network put the second message on the web page associated with the second user.

3. The method of claim 2 wherein said second message includes a link and identifies said first entity.

4. The method of claim 1 further comprising:
causing payment of at least some of said first donation to be made to said first entity.

5. The method of claim 1 further comprising:
causing payment of at least some of said first donation to be made to said first entity, less a pre-determined fee.

6. The method of claim 1 wherein the first entity is selected from:
(a) a political action committee (PAC);
(b) a political party;
(c) a politician; and
(d) a charity.

7. The method of claim 6 wherein the first donation or contribution is a political contribution.

8. The method of claim 1 further comprising:
recording and maintaining information about said first donation or contribution.

9. The method of claim 1 wherein the request to make the first donation or contribution is made via a second web page.

10. The method of claim 9 wherein the second web page is a page in the social network.

11. The method of claim 1 wherein the second user is the same as the first user.

12. The method of claim 1 wherein the web page associated with the second user is a social network page associated with the second user.

13. A non-transient computer-readable storage medium comprising computer-readable program code, the computer-readable storage code being executable by a processor to perform a process comprising:
(a) obtaining, from a first user of a social network, a request to make a first donation or contribution to a first entity; and
(b) in response to payment by said first user of value corresponding to said donation or contribution, causing a message to be provided to a second user of said social network, wherein said message is provided to said second user via said social network, the message being provided by causing the social network put the message on a web page associated with the second user, said message including an indication that said donation has been made to said first entity, said message including a link and identifying said first entity.

14. The computer-readable storage medium of claim 13 wherein the process further comprises:
(c) in response to a third user of said social network selecting said link, obtaining from said third user a request to make a second donation or contribution to said first entity; and
(d) in response to payment by said third user of value corresponding to said second donation or contribution, causing a second message to be provided to said second user, said second message indicating that said second donation has been made to said first entity.

15. The computer-readable storage medium of claim 13 wherein said second message includes a link and identifies said first entity.

16. The computer-readable storage medium of claim 13 wherein the process further comprises:
causing payment of at least some of said first donation to be made to said first entity.

17. The computer-readable storage medium of claim 13 wherein the process further comprises:
causing payment of at least some of said first donation to be made to said first entity, less a pre-determined fee.

18. The computer-readable storage medium of claim 13 wherein the first entity is selected from:
(a) a political action committee (PAC);
(b) a political party;
(c) a politician;
(d) a charity.

19. The computer-readable storage medium of claim 18 wherein the first donation or contribution is a political contribution.

20. The computer-readable storage medium of claim 13 wherein the process further comprises:
recording and maintaining information about said first donation or contribution.

21. The computer-readable storage medium of claim 13 wherein the request to make the first donation or contribution is made via a second web page.

22. The computer-readable storage medium of claim 21 wherein the second web page is a page in the social network.

23. The computer-readable storage medium of claim 13 wherein the second user is the same as the first user.

24. The computer-readable storage medium of claim 13 wherein the web page associated with the second user is a social network page associated with the second user.

25. A device operable in conjunction with a social network, the device comprising hardware and software, in conjunction with said hardware constructed and adapted to:
obtain, from a first user of said social network, and using an application available to users of said social network, a request from said first user to make a first donation to a first donee entity on behalf of a second user of said social network; and
in response to payment by said first user of value corresponding to said donation or contribution, cause a message to be provided to a second user of said social network, wherein said message is provided to said second user via said social network, the message being provided by causing the social network put the message on a web page associated with the second user, said message including an indication that said donation has been made to said first entity, said message including a link and identifying said first entity, wherein the web page associated with the second user is a social network page associated with the second user.

26. A computer-implemented method, implemented by hardware in combination with software, the method comprising:
obtaining, from a first user of a social network, a request to make a first donation or contribution to a first entity, wherein the first entity is selected from: (a) a political action committee (PAC); (b) a political party; (c) a politician; and (d) a charity;
in response to payment by said first user of value corresponding to said donation or contribution, causing a message to be provided to a second user of said social network, wherein said message is provided to said second user via said social network, the message being provided by causing the social network put the message on a web page associated with the second user, the web page associated with the second user being a social network page associated with the second user, said message including an indication that said donation has been made to said first entity, said message including a link and identifying said first entity;
causing payment of at least some of said first donation to be made to said first entity;
recording and maintaining information about said first donation or contribution;
wherein the request to make the first donation or contribution is made via a second web page.

27. The method of claim 26 further comprising:
in response to a third user of said social network selecting said link, obtaining from said third user a request to make a second donation or contribution to said first entity; and
in response to payment by said third user of value corresponding to said second donation or contribution, causing a second message to be provided to said second user, said second message indicating that said second donation has been made to said first entity, wherein said second message is provided to said second user via said social network, the second message being provided by causing the social network put the second message on the web page associated with the second user.
